(19) United States
(12) Patent Application Publication
(10) Pub. No.: US 2015/0017309 A1
(43) Pub. Date: Jan. 15, 2015

(54) NUTRITIONALLY BALANCED FOOD OR BEVERAGE PRODUCT

(71) Applicant: SAPPORO HOLDINGS LIMITED, Hamilton (NZ)

(72) Inventors: Guy William Clayton Pope-Mayell, Hamilton (NZ); Ross Dixon Rotherham, Hamilton (NZ); Jason Paul Rogers, Hamilton (NZ)

(21) Appl. No.: 14/384,856

(22) PCT Filed: Mar. 13, 2013
(86) PCT No.: PCT/NZ2013/000039

§ 371 Date: Sep. 12, 2014

(30) Foreign Application Priority Data
Mar. 13, 2012 (NZ) 598763

(51) Int. Cl. A23L 1/29; A23L 2/52

(52) U.S. Cl. CPC A23L 1/296; A23L 2/52; A23V 2002/00
USPC 426/590; 426/648

(57) ABSTRACT

A pre-packaged food or beverage product is provided in which each complete serving of the product includes at least two macronutrients selected from protein, fat, or carbohydrates wherein each selected macronutrient is in an amount which provides the same relative proportion of the NRV as the selected other macronutrient, but wherein the third macronutrient is not present in the same relative proportion as the two selected macronutrients, and wherein each complete serving of the product also includes fibre in the same relative proportions of the NRV as the two selected macronutrients.

### STATEMENT OF CORRESPONDING APPLICATIONS

This application is based on the Provisional specification filed in relation to New Zealand Patent Application Number 598763, the entire contents of which are incorporated herein by reference.

### TECHNICAL FIELD

The Invention relates to a nutritionally balanced food or beverage product for human consumption and processes for making same.

### BACKGROUND ART

Today there are a multitude of manufactured food and beverage products in the market place which have been developed by food technologists and dieticians. The primary driver for most manufactured and commonly available food products available today, are taste, followed closely by shelf life and texture. These drivers in turn dictate the overall nutritional composition, and choice of ingredients of the majority of so called healthy food products and beverages, available on supermarket shelves.

In addition, there are also many food and beverage products which have been designed to help or prevent a number of medical conditions or perform a particular function that helps in an individual achieving a particular goal. For example, there are healthy snacks such as nutrition bars with added calcium to address osteoporosis. Another example is protein bars which are high in protein and low in carbohydrate. So in general most tailored food products tend to solely focus on one, or may be at best two, nutritional goals.

However, with increasingly busy lifestyles and most people being starved for time, there is now, a greater need than ever, for food and beverage products, which if consumed: provide a person with appropriate amounts of all essential macronutrients so as to maintain a healthy diet and a healthy body. Particularly, if said food or beverage products are to be consumed over a prolonged period of time. The documentary Supersize Me is a poignant example of how manufactured food which is not balanced, can if consumed over an extended period of time, have extremely damaging effects on our health.

In this regard the applicant has previously developed a nutritionally balanced food product detailed in WO 2006/098644 which has the same relative proportions of calories, protein, carbohydrates, fat in every mouthful consumed. The food and beverage product taught in WO 2006/098644 represents what can be considered a new class of food and beverage products, one which is designed to provide a healthy person's body with that, which it actually requires. That is WO 2006/098644 teaches a food product which has macronutrients of protein, fat and carbohydrate all matched to the same percentage of the RDI—that is a food product having totally nutritionally balanced macronutrients.

It is also now recognised that at different times in their life, people may have a desire, or need, to increase or decrease their consumption of certain macronutrients outside of the daily intake parameters, in order to achieve some desirous or beneficial outcome. Accordingly, it would be useful, if there could be provided a tailored food or beverage product, which has a particular nutritional focus with respect to one macronutrient, yet strives to maintain a balance in accordance with daily intake guidelines, with respect to the other macronutrients.

It would therefore be useful, if there could be provided a food and beverage product which is tailored to suit an end user's requirements. For example, a food or beverage product which tailored in one aspect, yet is a product which also seeks to look after the other nutritional needs of an individual. Such a product can go along way to ensuring that despite a dietary focus on one or more nutrient(s): there is retained a sufficient overall nutritional balance to ensure: healthy growth, repair and maintenance of an individual's body. Put another way, it would be useful if there existed a food or beverage product, which whilst high or low (with respect to the daily intake for a serving size) for one particular macronutrient—in order to achieve a dietary aim with respect to the daily intake for that macronutrient—at the same time, has all the other macronutrients, present in the same relative proportions of the daily intake per serving.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DEFINITIONS

The term ‘carbohydrate’ as used herein includes both simple (mono and disaccharides) and complex (polysaccharides) carbohydrates. One example of a simple carbohydrate are sugars.

The term ‘fat’ as used herein includes ‘saturated’ fat and other subgroups of fats.

The term ‘NRV’ or ‘Nutritional Reference Value’ as used herein refers to reference amounts used to provide dietary nutritional guidance on the daily intake of nutrients including carbohydrates, protein, and fat. The reference amounts are typically published in food regulations or in accepted industry codes of practice or guidelines for the purpose calculating and expressing nutrient amounts in terms of a person's Daily Intake or equivalent terms including: Daily Nutritional Requirement, Daily Allowance, Daily Value, Recommended Daily Value, Recommended Daily Intake, Guideline Daily Amounts or other similar terms or abbreviations thereof.

Representative examples of such published nutrient regulations and guidelines include:
Daily Reference Values given in USFDA Code of Federal Regulations 21 CFR 101.9, 1996;
% Daily intake reference values given in the Australia New Zealand Food Standards
GDA—Guideline Daily Amounts as published by the Food and Drink Federation, UK
Reference Standards given in The Canadian Food and Drug Regulations and amendments;
   such as may be periodically updated from time to time. A summary of the above published nutrient regulations and guidelines for Australia/New Zealand, UK, US and Canada is shown in Table 1 and is for illustrative purposes only.

TABLE 1

| | AUS/NZ | | | | | | | |
|---|---|---|---|---|---|---|---|---|
| | DV/DAILY | | UK | | US | | Canada | |
| | INTAKE | | GDA (UK) | | RDV | | RDV | |
| Energy (kJ) | 8700 | | 8360 | | 8360 | | 8360 | |
| Cal | 2081 | | 2000 | | 2000 | | 2000 | |
| Protein | 50 | g | 50 | g | 50 | g | None set | |
| Fat, Total | 70 | g | 70 | g | 65 | g | 65 | g |
| Fat Sat | 24 | g | 20 | g | 20 | g | 20 | g |
| Cholesterol | None set | | None set | | 300 | mg | 300 | mg |
| Total Carb | 310 | g | 270 | g | 300 | g | 300 | g |
| Sugars | 90 | g | 90 | g | None set | | None set | |
| Fibre | 30 | g | 25 | g | 25 | g | 25 | g |
| Sodium | 2300 | mg | 2400 | mg | 2400 | mg | 2400 | mg |

### SUMMARY OF INVENTION

According to a first aspect there is provided a process for manufacturing a food or beverage product which is based upon the nutritional reference values (NRV) as a starting point and which has a focus on increasing or decreasing the relative amounts of one macronutrient yet is balanced with respect to the other macronutrients, the process comprising the steps of:
(i) selecting a first percentage of the (NRV) that will be used to determine an amount of two macronutrients selected from protein, fat or carbohydrate that will be in the product;
(ii) selecting a second percentage of the NRV that will be used to determine an amount of the third macronutrient that will be in the product, wherein said second percentage of the NRV for the third macronutrient, is not the same as the first percentage for the other two macronutrients;
(iii) combining the protein, fat and carbohydrate macronutrients in amounts as determined at steps (i) and (ii) above.

It will be understood that some or all of the individual macronutrients will generally present in various quantities within individual ingredients selected for creating a recipe such as would be understood by a person skilled in the art. For this reason step (iii) in practice may a number of sub-steps: which may include but not be limited to, blending, cutting, mixing one or more of the ingredients separately or together; prior to incorporating with one or more other ingredients, before finally combining/bringing together the macronutrients so as to create a complete serving. According to a second aspect of the present invention there is provided a pre-packaged food or beverage product in which each complete serving of the product includes at least two macronutrients selected from protein, fat, or carbohydrates wherein each selected macronutrient is in an amount which provides the same relative proportion of the NRV as the selected other macronutrient but wherein the third macronutrient not present in the same relative proportion as the two selected macronutrient, and wherein each complete serving of the product also includes fibre in the same relative proportions of the NRV as the two selected macronutrients.

According to a third aspect there is provided a pre-packaged food or beverage substantially as described above wherein the same relative proportion of the NRV is substantially selected from within the range of 5% to 50% of the daily intake for each of selected macronutrients.

According to a fourth aspect of the present invention there is provided a pre-packaged food or beverage product in which each complete serving of the product includes at least two macronutrients selected from protein, fat, or carbohydrates wherein each selected macronutrient is in an amount which provides the same relative proportion of the NRV as the selected other macronutrient but wherein the third macronutrient is not present in the same relative proportion as the two selected macronutrients.

In some embodiments the product supplies substantially the same relative proportion of the NRV for energy as is provided the two selected macronutrients.

A pre-packaged food or beverage substantially as described above wherein the NRV is calculated based on the average daily energy requirements of a child or an adult.

The invention may also be said broadly to consist in the parts, elements and features referred to or indicated in the specification of the application, individually or collectively, in any or all combinations of two or more of said parts, elements or features.

### BEST MODES AND ILLUSTRATIVE EXAMPLES

The following examples are illustrative only and are not intended to limit the scope of the invention and are based on % Daily intake reference values given in the Australia New Zealand Food Standards.

### Example 1

A bar which has 50% of the NRV for protein, carbohydrate and fibre and less than 33.3% of the NRV for fat.

| | | |
|---|---|---|
| Protein | 25 | g |
| Carbohydrate | 155 | g |
| Fat | 20 | g |
| Fibre | 15 | g |
| Energy | 966 | Cal |

This example provides a bar having a super high protein and carbohydrate content with 46% of daily energy and less than a third of the daily NRV for fat—ideal for a busy amateur athlete on the go in a Triathlon or Rogaine with limited time to eat. A professional athlete may well have a higher daily energy requirement and thus amounts of protein, carbohydrates and fat would be proportionally increased.

This bar will weigh around 250 g. Given the size of this bar which will be one of the biggest if not the biggest on the market it will be packaged as two individual bars presented as a single unit similar to the ONE SQUARE MEAL™ bar marketed in New Zealand and Australia as a single packet containing two individually wrapped bars.

### Formulation to Achieve Example 1

| | |
|---|---|
| | % of syrup (in-going |
| Ingredient | ingredient weight) |

Syrup

| Step 1 | Manuka Honey | 7.6% |
|---|---|---|
| | Glycerine | 2.6% |
| | Brown Rice Syrup | 29.5% |
| Step 2 | Maltodextrin | 25.3% |
| | Cocoa Powder | 4.2% |
| | Water | 2.53% |
| | Salt | 0.6% |
| Step 3 | Rice Bran Oil | 4.3% |
| | Lecithin | 0.8% |
| | Coconut oil | 1.7% |
| | Milk Chocolate | 21.0% |
| | Totals | 100% |
| | | % of Mass |

Final Mass

| | | |
|---|---|---|
| Step 5 | Cooked Syrup | 42.84% |
| | Rolled Oats | 37.62% |
| | Acacia gum | 1.56% |
| | Soy nugget | 4.41% |
| | Cornflakes | 7.61% |
| | Raisins | 4.57% |
| | Vanilla flavour | 0.24% |
| | Chocolate flavour | 0.45% |
| | Water | 0.39% |
| | Vitamin & Mineral premix | 0.29% |
| | Totals | 100% |

### Method:

Step 1 ingredients should be added to a cooking vessel and blended while heating to 80° C. Step 2 ingredients may then be added and a shear device such as a shear pump or Silverson shear head used to disperse and blend these, while heating to 90° C. In a separate cooking vessel, the step 3 ingredients should be prepared. The coconut oil should be pre-melted, then blended with the other step 3 ingredients at a temperature not exceeding 60° C. in order to fully disperse the lecithin. Once prepared, this oil phase is added to the hot syrup already prepared and blended utilizing high shear. The final mass may be prepared mixing together the step 5 ingredients including the cooked syrup (at a temperature of 85° C.-95° C.) in a mixer such as a ‘Z Arm’ or Sigma mixer. The flavour and vitamin and mineral premix should be added last to minimise exposure to higher temperatures. Individual bars may then be formed via a sheet and cut process.

### Example 2

A bite size snack bar which has 5% of the NRV for protein, carbohydrate and fibre and 10% of the NRV for fat.

| | | |
|---|---|---|
| Protein | 2.5 | g |
| Carbohydrate | 15.5 | g |
| Fat | 7 | g |
| Fibre | 1.5 | g |
| Energy | 138 | Cal |

This bar would be approximately 30 g in size.

This example provides a quick snack for athletes which is high in energy. It may also be formulated as a beverage or other good suitable for burns victims.

### Formulation to achieve Example 2

| | |
|---|---|
| | % of syurp (in-going |
| Ingredient | ingredient weight) |

Syrup

| Step 1 | Honey | 3.5% |
|---|---|---|
| | Brown Rice Syrup | 22.8% |
| Step 2 | Maltodextrin | 11.4% |
| | Cocoa Powder | 3.5% |
| | Water | 1.76% |
| | Salt | 0.2% |
| Step 3 | Rice Bran Oil | 21.1% |
| | Lecithin | 0.6% |
| | RBD Coconut oil | 17.6% |
| | Milk Chocolate | 17.6% |
| | Totals | 100% |
| | | % of Mass |

Final Mass

| | | |
|---|---|---|
| Step 4 | Cooked Syrup | 47.75% |
| | Rolled Oats | 34.42% |
| | Acacia gum | 0.97% |
| | Soy crisps | 2.67% |
| | Cornflakes | 12.85% |
| Step 5 | Vanilla flavour | 0.27% |
| | Chocolate flavour | 0.51% |
| | Water | 0.24% |
| | Vitamin & Mineral Premix | 0.34% |
| | Totals | 100% |

### Method:

This bar could be manufactured according to the method described in example 1.

### Example 3

A bar which has 40% of the NRV for protein, fat and fibre and 10% of the NRV for carbohydrate.

| | | |
|---|---|---|
| Protein | 20 | g |
| Carbohydrate | 31 | g |
| Fat | 28 | g |
| Fibre | 12 | g |
| Energy | 488 | Cal |

This bar will weigh around 105 g total.

### Formulation to Achieve Example 3

| | |
|---|---|
| | % of syurp (in-going |
| Ingredient | ingredient weight) |

Syrup

| Step 1 | Manuka Honey | 3.3% |
|---|---|---|
| | Glycerine | 5.2% |
| | Brown Rice Syrup | 18.7% |
| Step 2 | Cocoa Powder | 3.1% |
| | Water | 1.56% |
| | Salt | 0.2% |
| Step 3 | Rice Bran Oil | 33.1% |
| | Lecithin | 0.6% |
| | Coconut oil | 18.7% |
| | Milk Chocolate | 15.6% |
| | Totals | 100% |
| | | % of Mass |

Final Mass

| | | |
|---|---|---|
| Step 5 | Syrup | 43.77% |
| | Rolled Oats | 26.66% |
| | Acacia gum | 9.89% |
| | Soy nuggets | 18.66% |
| Step 6 | Vanilla flavour | 0.24% |
| | Chocolate Flavour | 0.46% |
| | Vitamin & Mineral Premix | 0.30% |
| | Totals | 100% |

### Method:

This bar could be manufactured according to the method described in example 1.

### Example 4

A frozen meal which includes 50% of the NRV for protein, carbohydrate and fibre and less than 33.3% of the NRV for fat.

| | | |
|---|---|---|
| Protein | 25 | g |
| Carbohydrate | 155 | g |
| Fat | 20 | g |
| Fibre | 15 | g |
| Energy | 941 | Cal |

This is a chilli con carne designed to be healthy and satiate the consumer of the meal. It has a serving size of 745 g.

### Formulation and Method to Achieve Example 4

| | % of syurp (in-going |
|---|---|
| Ingredient | ingredient weight) |
| Rice Bran Oil | 1.7% |
| Chopped Onion | 6.4% |
| Diced Capsicum red | 4.9% |
| Finely chopped Garlic | 0.4% |
| Chilli Powder | 0.2% |
| Paprika | 0.2% |
| Cumin | 0.2% |
| Beef mince, 70% lean | 11.6% |
| Maize starch | 6.6% |
| Maltodextrin | 3.3% |
| Water | 16.5% |
| Acacia gum | 2.3% |
| Beef stock dried | 0.40% |
| Chopped Tomatoes | 32.92% |
| Sugar | 0.3% |
| Tomato puree | 2.1% |
| Salt | 0.2% |
| Kidney beans, cooked and drained | 9.9% |
| Totals | 100.0% |

### Method:

The rice bran oil should be heated in a cooking vessel before adding the chopped onion and cooking until caramelised. The diced capsicum, chopped garlic and spices should then be added to the mixture and cooked for a further 5 minutes. The beef mince should then be added and cooked with agitation/stirring until fully browned.

In a separate cooking vessel, a slurry should be prepared comprising the water (@ 50-60° C.), maize starch, maltodextrin, acacia gum and beef stock. Pre-blending of these dry powders should aid the dispersion of the acacia gum. The slurry is then added to the cooking mixture, which should be heated to boiling before reducing the heat to a simmer. The chopped tomatoes, sugar, salt, tomato puree and drained kidney beans should then be added and stirred in. The entire mixture should be heated to approximately 100° C. (without boiling) and cooked for a further 10 minutes. The cooked mixture may then be cooled, before portioning with boiled/drained white rice, comprising a finished meal of 42% chilli con carne/58% rice. This may be packaged in microwavable plastic trays and blast frozen.

### Example 5

This example is for a beverage which has the same nutritional profile as for example 4 except it is formulated as a beverage and the amount of protein, carbohydrate and fat is halved to create a 600 mL serving.

### Formulation and Method to Achieve Example 5

| | | % in-going |
|---|---|---|
| | Ingredient | ingredient weight |
| Part A | Soy Protein Isolate | 1.0% |
| | Skim Milk Powder | 3.9% |
| | Water | 31.4% |
| Part B | Water | 49.0% |
| | Oligofructose | 1.3% |
| | Maltodextrin | 7.0% |
| | Carrageenan | 0.028% |
| | Microcrystaline cellulose | 0.233% |
| Part C | Brown Rice Syrup | 3.5% |
| | Honey | 1.9% |
| Part D | Rice Bran Oil | 0.4% |
| Part E | Vanilla flavour | 0.40% |
| | Totals | 100.0% |
| Part A | Soy Protein Isolate | 1.0% |
| | Skim Milk Powder | 3.9% |
| | Water | 31.4% |
| Part B | Water | 49.0% |
| | Oligofructose | 1.3% |
| | Maltodextrin | 7.0% |
| | Carrageenan | 0.028% |
| | Microcrystaline cellulose | 0.233% |
| Part C | Brown Rice Syrup | 3.5% |
| | Honey | 1.9% |
| Part D | Rice Bran Oil | 0.4% |
| Part E | Vanilla flavour | 0.40% |
| | Totals | 100.0% |

### Method:

The soy protein isolate and skim milk should be dispersed using shear/agitation in the part A water (@40-50° C.) and left to hydrate (assisted by agitation) for 10-15 minutes. In a separate vessel, the carrageenan, microcrystalline cellulose, maltodextrin and oligofructose should be dispersed in the part B water (@40-50° C.). Dispersion may be aided by pre-blending of the dry powders. These should be left to hydrate (with agitation) for 15-20 minutes, prior to adding and blending the brown rice syrup, honey and soy protein isolate/skim milk powder (part A). The rice bran oil should then be added and blended using shear and finally the flavor added and mixed. This mixture is then processed by ultra heat treatment (approximately 140° C. for 6-7 seconds) and homogenized, prior to aseptic packaging.

### Example 6

This example is for a beverage which has the same nutritional profile as for example 5 except it does not have fibre matched to the same NRV as the matched NRV for protein and carbohydrate.

| | | |
|---|---|---|
| Protein | 12.5 | g |
| Carbohydrate | 77.5 | g |
| Fat | 3.3 | g |
| Fibre | 0.1 | g |
| Energy | 395 | Cal |

The serving size is 600 ml.

### Formulation and Method to Achieve Example 6

| | | % in-going |
|---|---|---|
| | Ingredient | ingredient weight |
| Part A | Soy Protein Isolate | 1.0% |
| | Skim Milk Powder | 3.9% |
| | Water | 31.4% |
| Part B | Water | 50.3% |
| | Maltodextrin | 7.1% |
| | Carrageeenan | 0.028% |
| | Microcrystalline cellulose | 0.233% |
| | Brown Rice Syrup | 3.5% |
| | Honey | 1.9% |
| Part C | Rice Bran Oil | 0.4% |
| Part D | Vanilla flavour | 0.40% |
| | Totals | 100.0% |

### Method:

The soy protein isolate and skim milk should be dispersed using shear/agitation in water (@40-50° C.) and left to hydrate (assisted by agitation) for 10-15 minutes. In a separate vessel, the carrageenan, microcrystalline cellulose and maltodextrin should be dispersed in water (@40-50° C.). Dispersion may be aided by pre-blending of the dry powders. These should be left to hydrate (with agitation) for 15-20 minutes, prior to adding and blending the brown rice syrup, honey and soy protein isolate/skim milk powder. The rice bran oil should then be added and blended using shear and finally the flavor added and mixed. This mixture is then processed by ultra heat treatment (approximately 140° C. for 6-7 seconds) and homogenized, prior to aseptic packaging.

### DETAILED DISCUSSION OF ALTERNATIVE WAYS TO IMPLEMENT THE INVENTION

In some embodiments the actual age group of a child or adult may be further classified into one or more further categories. For example:
A food or beverage substantially as described above wherein the average daily energy requirements are also calculated based on whether the child or adult is a female or male.
A food or beverage substantially as described above wherein the age group of the adult or child is taken into consideration when calculating the energy requirements.

In some embodiments the average daily energy requirements may be based on those of an average. For example the daily energy requirements can be based on an adult female such as is used for the GDA, or an average of the figures for males and females which is used in the Australia New Zealand Food Standards.

In some embodiments the NRV for energy may be around 8000-9000 kJ or around 2000-2100 Cal.

The advantage of selecting an NRV calculated on the average daily energy requirements of an adult is that for it helps achieve a lower cost of manufacture, as the product can be produced from a single production line.

In many instances the invention may be designed as a snack or partial meal replacement

In other embodiments the invention may be employed for meeting the needs of a particular market segment with nutritional requirements which are quite different to those of the average adult. For example, endurance athletes may require a super high energy bar or beverage. Alternatively, post operational humans, or extreme body builders, may require a super high protein food or beverage to enable rapid muscle growth following muscle atrophy. Another group which may have particular nutritional needs that differ from the NRV of the average adult is infants who may be moving from milk onto solids.

In some embodiments the food or beverage according to the invention may be formulated to have a long shelf life.

In some embodiments the food or beverage product according to the invention includes one or more essential minerals and vitamins in the same relative proportion of the NRV as the selected macronutrients. In some embodiments the minerals and vitamins may include one or more of vitamins A, B1, B2, B6, B12, C, D and E; niacin; foliate; calcium; iodine; iron; magnesium; phosphorous; and zinc.

In some embodiments the food product of the present invention has a shelf life of at least three months.

Aspects of the present invention as detailed herein have been described by way of example only and it should be appreciated that modifications and additions may be made thereto without departing from the scope of the appended claims.

1. A process for manufacturing a food or beverage product which is based upon the nutritional reference values (NRV) as a starting point and which has a focus on increasing or decreasing the relative amounts of one macronutrient yet is balanced with respect to the other macronutrients, the process comprising the steps of:
(i) selecting a first non-zero percentage of the (NRV) that will be used to determine an amount of two macronutrients selected from protein, fat or carbohydrate that will be in the product, from any one of the following documents:
Daily Reference Values given in USFDA Code of Federal Regulations 21 CFR 101.9, 1996;
% Daily Intake reference values given in the Australia New Zealand Food Standards;
GDA—Guideline Daily Amounts as published by the Food and Drink Federation, UK;
Reference Standards given in The Canadian Food and Drug Regulations and amendments;
all as published on 13 Mar. 2012;
(ii) selecting a second percentage of the NRV that will be used to determine an amount of the third macronutrient that will be in the product, wherein said second percentage of the NRV for the third macronutrient, not selected in step (i), is not the same as the first percentage for the other two macronutrients; and
(iii) combining the protein, fat and carbohydrate macronutrients in amounts as determined at steps (i) and (ii) above.

2. A process as claimed in claim 1 comprising the additional step of adding fibre in the same relative proportions of the NRV as the two selected macronutrients.

3. A pre-packaged food or beverage product produced by the process of claim 1.

4. A pre-packaged food or beverage product manufactured according to the process of claim 1.

5. A pre-packaged food or beverage product as claimed in claim 4 wherein the same relative proportion of the NRV is substantially within 5% to 50% of the daily intake for each of selected macronutrients.

6. A pre-packaged food or beverage product as claimed in claim 4 wherein the NRV is calculated based on the average daily energy requirements of a child or an adult.

7. A pre-packaged food or beverage product as claimed in claim 6 wherein the average daily energy requirements are also calculated based on whether the child or adult is a female or male.

8. A pre-packaged food or beverage product as claimed in claim 7 wherein the age group of the adult or child is taken into consideration when calculating the energy requirements.

9. A pre-packaged food or beverage product as claimed in claim 4 wherein the average daily energy requirements are based on those of an average adult female.

10. (canceled)

11. A pre-packaged food or beverage product as claimed in claim 9 wherein each complete serving of the product also includes fibre in the same relative proportions of the NRV as the two selected macronutrients.

12. (canceled)

13. (canceled)
